(19) United States
(12) Patent Application Publication
(10) Pub. No.: US 2018/0336488 A1
(43) Pub. Date: Nov. 22, 2018

(54) Machine Learning Based Family Relationship Inference

(71) Applicant: Microsoft Technology Licensing, LLC, Redmond, WA (US)

(72) Inventors: Yaxiong CAI, Redmond, WA (US); Qiang LI, Redmond, WA (US); Xiaoguang QI, Bellevue, WA (US); Alexander Vincent MOORE, Seattle, WA (US); Shan YANG, Bellevue, WA (US); Vardan TOVMASYAN, Bothell, WA (US); Cezary MARCJAN, Redmond, WA (US); Pranavakumar PUNNIAMOORTHY, Redmond, WA (US); Harish JAYANTI, Redmond, WA (US); Jayaram NANDURI, Issaquah, WA (US)

(73) Assignee: Microsoft Technology Licensing, LLC, Redmond, WA (US)

(21) Appl. No.: 15/598,096

(22) Filed: May 17, 2017

(51) Int. Cl. G06N 99/00; G06Q 50/00; G06N 5/04; G06N 7/00

(52) U.S. Cl. CPC G06N 99/005; G06N 7/005; G06N 5/04; G06Q 50/01

(57) ABSTRACT

Aspects provided herein are relevant to systems, methods, and techniques for classifying relationships between people (e.g., users of a platform or ecosystem) based on relationship data. In an example, the relationship data can be provided as input into a two-layer classification framework in which the first layer acts a filter for the second layer. The framework can identify relationships such as a self-relationship (e.g., two different accounts on the platform are operated by the same person), a non-self, family-member relationship (e.g., two users are different people but part of the same family), and a non-family-member relationship (e.g., the two users are different people and not part of the same family, such as coworkers or roommates).

### BACKGROUND

Many platforms encourage customers to identify their social relationships. For example, MICROSOFT XBOX LIVE allows users to specify family settings and social network settings. As another example, many social networks allow users to explicitly identify particular family members or friends. Although, user-specified information is a helpful source of data, the number of family relationships and other social relationships explicitly identified by customers is small compared to the true count. Further, there are also cases where users add non-family members such as friends to family relationships settings.

It can be advantageous to understand social relationships among users, even where they are not explicitly identified by a user. Knowledge of these relationships can be used in a variety of ways. For example, platforms can offer special functionality to family members (e.g., special sharing settings, special security settings, and special permissions). In another example, family or friend relationship information can be used to connect family members on platforms (e.g., suggesting them as contacts in a messaging platform).

It is with respect to these and other general considerations that the aspects disclosed herein have been made. Although relatively specific problems may be discussed, it should be understood that the examples should not be limited to solving the specific problems identified in the background or elsewhere in this disclosure.

### SUMMARY

In general terms, this disclosure relates to classifying relationships based on relationship data, such as relationships between users of a platform or ecosystem. The relationship data can be provided as input into a two-layer classification framework in which the first layer acts a filter for the second layer. The framework can identify relationships such as a self-relationship (e.g., where the users are not actually two different people, as may be found when two different accounts on the platform are operated by the same person), a non-self, family-member relationship (e.g., two users are different people but part of the same family), and a non-self, non-family-member relationship (e.g., the two users are different people and not part of the same family, such as coworkers, friends, roommates, acquaintances, or strangers). Techniques disclosed herein can also be applied to identify other types of relationships, such as coworker relationships and social influencer relationships, among others.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system and method for classifying relationships.

FIG. 2 illustrates an example process for building a framework and applying the framework the input data.

FIG. 3 illustrates an example classification engine implementing a process for classifying a relationship based on relationship data.

FIG. 4 is a block diagram illustrating example physical components of a computing device with which aspects of the disclosure may be practiced.

FIG. 5A illustrates a mobile computing device with which embodiments of the disclosure may be practiced.

FIG. 5B is a block diagram illustrating the architecture of one aspect of a mobile computing device.

FIG. 6 illustrates one aspect of the architecture of a system for processing data received at a computing system from a remote source.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

Disclosed systems and methods relate to identifying relationships, such as family-member relationships and other relationships (e.g., coworker or social influencer relationships), using machine-learning techniques. It can be advantageous for platforms to understand relationships between users, such as family-member relationships. However, traditional techniques for determining such relationships have drawbacks. A common way to identify relationships is to rely on information provided by users themselves. Many platforms give users the opportunity to explicitly specify relationships. However, not all users specify their relationships. And where users do specify relationships, the information may be an incomplete or inaccurate list. For example, some users may specify sibling relationships but not parent relationships. As another example, some users may specify their friends as family members.

Another approach for determining relationships can include the use of human-crafted rules based on domain knowledge. For example, administrators can create rules based on various characteristics of relationship data to determine whether not users have a particular relationship. However, this approach can create a high rate of false positives. For example, the two users may be indicated as being family members in the rule-based system, but instead the users may actually be roommates or even the same person.

There exists a need in the art for automatically identifying social relationships between users in an accurate manner. However, there exist difficulties in automating such identification using the computer. Human relationships are often subtle and can be hard to evaluate quantitatively. Given enough information about a user and the user's interaction with others in an ecosystem, human judges may be able to make consistent decisions on whether two persons are family members or not. But those determinations often include qualitative and subjective measures that can be difficult to automate on a computer. And a human judge can only provide a limited number of determinations, which limits the scalability of this approach. For example, it would take a significant number of judges a significant amount of time to determine all customers' relationship for a large commercial company. Disclosed embodiments are relevant to overcoming one or more difficulties in using a computer to identify relationships among users.

In an example, relationship data can be extracted from a knowledge graph. Human judges can examine the relationship data and classify or tag relationships inferred by the framework using the data. For example, a relationship can be tagged as a friend relationship, a coworker relationship, a family-member relationship, a self-relationship or another kind of relationship. This tagged relationship data can then be used as training data to train a machine-learning framework. Once properly trained, the machine-learning framework can be automatically applied to raw untagged relationship data and used to classify the relationships.

In an example, the machine-learning framework can use a two-layer approach. In a first layer, the machine-learning framework can classify the relationship as either a non-family-member relationship or a general family-member relationship. The general family-member relationship can include relationships among family members (e.g., a user may have a spouse, parent-child, guardian-child, sibling, or other family-member relationship) as well as a self-relationship (e.g., two users may not actually be two different people, but may actually be the same person). The definition of family can be flexible and can include traditional family relationships (e.g., a nuclear family) as well as non-traditional family relationships. In some examples, the definition of family-member relationships can be customized for particular purposes. In one instance, the definition of family member can be narrow (e.g., just spouse, parent-child, or sibling relationships), and in another instance the definition of family member can be broader (e.g., including cousins, grandparents, uncles, aunts, and people living together)

The first layer of the framework can act as a filter to improve the accuracy of the results of the second layer. In addition, this two-layer framework allows for the use of binary classifiers to process the data. Further, this approach allows for the classification and identification of self-relationships. These self-relationships can have many similar properties to family relationships (e.g., sharing a same address and sharing a same family name), which may make the identification of self-relationships difficult.

A self-relationship exists where the relationship is not between two different people but instead represents the same person. For example, a person may have multiple different accounts, such as a work account and a home account. The relationship between two accounts of the same person can be described as a self-relationship. For the purposes of the first layer however, such a self-relationship can be considered part of a general family relationship. This is because there are often many similarities between a self-relationship and a family-member relationship. For example, family members often have the same home address. Similarly, two accounts having a self-relationship would have the same home address because one person is associated with both accounts.

After applying the first layer, those relationships identified as a general family-member relationship can be analyzed using a second layer of the framework. The second layer can classify the relationship as either a self-relationship or a non-self, family-member relationship. The relationship can be tagged accordingly.

The platform can use the tagged relationship data in a variety of ways. The platform can offer users having particular relationships special ways to interact. For example, there may be special sharing settings exposed to family members. In some examples, such special settings may require further confirmation from users, such as an explicit confirmation that the users are in fact family members or have a particular relationship. Other examples can include informing users of special opportunities available to them given their relationship. For example there may be a special family sharing plan for photos, music, or documents.

In still another example, such relationship data can be used to identify fraudulent behavior. For example, information that a large number of accounts have a self-relationship may be a factor indicating that the accounts are used for malicious activity (e.g., spam). By contrast, knowing that the accounts have a family-member relationship (even if such relationship is not explicitly identified by the related users) may be a factor indicating that the accounts are likely not malicious. In another example, the relationship data can be used as a factor indicating whether a purchase is fraudulent. For example, when one user is using another user's payment instrument, it is one thing if the two users have a family-member relationship (e.g., a child may be using a parent's credit card), and it is another thing if the two users have no relationship (e.g., an unknown user is using someone's credit card).

In a similar manner, family-member relationship data can be used to identify network activity. For example, relationship data can be used to perform spam detection or fraudulent message detection. For instance, by knowing that a message is coming from a likely family member (even if that relationship is not explicitly declared) or the same user (e.g., a self-relationship), a spam detection system can treat the message differently than if the message was coming from an unknown user.

The identification of relationships between users can increase user efficiency by reducing the number of interactions the user needs to make with a platform. For example, rather than needing to find and explicitly identify each family member on a platform, the system can automatically suggest family members to the user and the user need only confirm the relationship.

Disclosed aspects can include technical improvements that allow computers to produce accurate classification of relationships between users that would previously need to be produced by human judges. In an example, this improvement is realized through the application of machine-learning techniques. In another example, this improvement is realized through a two-step process of first classifying the relationship as a general family-member relationship or non-family-member relationship and second classifying the general family-member relationship as either a self-relationship or a non-self, family-member relationship. In yet another example, this improvement is realized through the extraction of relationship data from knowledge graphs and not merely limited to relationship data indicated by users (if any). These approaches are different from the qualitative approaches traditionally applied by a human judge of relationships.

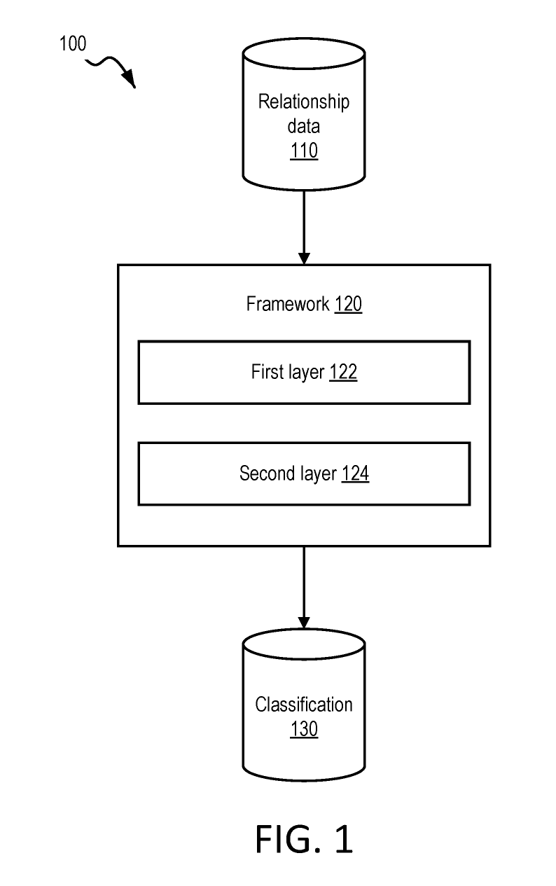

FIG. 1 illustrates an example system 100 for providing relationship data 110 as input to a framework 120 to produce a classification 130.

The relationship data 110 includes data relevant to a relationship among users. This relationship data 110 can include data about the relationship itself (e.g., whether users share a same family name, whether users are marked as friends on a social network, etc.), as well as data about the individual users themselves (e.g., a billing address of a user, a name of a user, an age of a user, etc.). The relationship data 110 can include user information and user interaction signals.

The relationship data 110 can be acquired from a variety of different sources. These sources can include, for example, data specified by the users as part of activity on a platform (e.g., a social network or a computing device), or through other sources. The sources can also include data inferred about the user by a platform (e.g., a home or office location inferred based on user location data), as well as data acquired about the user (e.g., computer or device usage behavior). In aspects, the user data can be collected, stored, and used according to well-defined privacy policies.

In an example, the relationship data 110 can be acquired from a social graph or a knowledge graph of users of a platform. For example, a knowledge graph may represent the users as nodes and relationships between the users as edges between nodes. Relationship data can be obtained by traversing the graph and acquiring relationship data from the edges, as well as information about the users from the nodes themselves.

As a specific example, the relationship data 110 can include information collected from one or more of: a user's account (e.g., a user's name, home address, shipping address, email address), a user's gaming account (e.g., a user's XBOX account), a user's gaming device usage data (e.g., the user may share a gaming device with other users), billing purchase data (e.g., payment instrument information), a user's gaming platform social graph, a user's multiplayer gaming usage data (e.g., which may identify which users the user plays games with), device telemetry information (e.g., information about a user's device and how the device is used), and user communication behavior (e.g., who the user communicates with, how often, and at what time). The collection and use of this information can be limited according to legal constraints and privacy policies regarding user data. Accordingly, depending on relevant constraints, the system 100 may be limited to using only certain sources and permissible combinations of information. In some instances, users may opt out from the use of their data for certain purposes, and the system 100 may avoid back-filling or inferring information in a way that could circumvent legal, policy, or user constraints.

In some examples, some or all of the user information may be hashed (e.g., by a security process) before analysis is performed. For example, the family names of user1 and user2 may both be “Smith”, and a hash function may hash “Smith” into “abc123”. When a reviewer sees the family names of user1 and user2, the reviewer would see “abc123” rather than “Smith”. When the reviewer sees that both user1 and user2 have a family name value of “abc123”, the reviewer can conclude that user1 and user2 have a family name match without needing to see the true family names of the users. In this manner, the privacy of the users can be protected without influencing the model and analysis.

Examples of features present in the relationship data 110 can include one or more of the following features as described in the following table.

TABLE I
Example Features

| Feature | Explanation |
|---|---|
| MatchingGivenName | Whether the users have same given (e.g., |
| | first) name |
| MatchingFamilyName | Whether the users have same family (e.g., |
| | last) name |
| SharedDevicesCount | How many devices (e.g., gaming consoles, |
| | laptop computers, desktop computers, or |
| | mobile devices) are shared by the users |
| SharedConfirmedMixedAddressesCount | How many confirmed addresses are shared |
| | by the users |
| SharedBillingAddressesCount | How many billing addresses are shared by |
| | the users |
| SharedConfirmedShippingAddressesCount | How many shipping addresses are shared |
| | by the users |
| SharedMixedAddressesCount | How many addresses are shared by the |
| | users |
| SharedConfirmedBillingAddressesCount | How many confirmed billing addresses are |
| | shared by the users |
| InGamingPlatformFamily | Whether one user set another user as family |
| | in a gaming platform |
| InOperatingSystemFamily | Whether one user set another user as family |
| | in an operating system |
| FriendsOnGamingPlatform | Whether one user set another user as friend |
| | in a gaming platform |
| SharesIdentityWithOnGamingPlatform | Whether the users share an identity on a |
| | gaming platform. |
| ReceivedEmailsCount | The number of emails received from |
| | another user |
| SentEmailsCount | The number of emails sent from another |
| | user |
| SharedPICount | How many same payment instruments (e.g., |
| | credit cards) the users have used |
| FavorsOnGamingPlatform | Whether one user set another user as |
| | favorite on a gaming platform |
| FollowedByOnGamingPlatform | Whether one user is followed by another |
| | user on a gaming platform |
| FollowsOnGamingPlatform | Whether one user follows another user on a |
| | gaming platform |
| ViaAlternateEmails | Whether one user set another user's email |
| | as alternative email |

The formatting of the feature can affect the effectiveness of its use in determining the relationship of the user. For example, when analyzing a user's family name, one example approach may involve determining whether two users have the same family name. If the users have the same family name, then a Boolean is set as true. Otherwise, it is set as false. However, this may negatively affect results because sometimes users do not provide their family names. In those instances, users that do not fill in their family names would be counted as a non-match. But actually it is unknown whether the names match because one name was not provided. Another example approach can address these situations by assigning the feature three different values. A first value can indicate that the names truly match (e.g., both names are identical). A second value can indicate that the names truly do not match (e.g., both names are not the same). A third value can be given if there is insufficient information to make a determination (e.g., one or both of the users' names are missing). In this manner, the framework may be able to account for situations where information is missing without assuming that there is not a match. In some examples, the third value may also be given if the names are close but not an identical match (e.g., within a suitable threshold of each other). This process may provide increased flexibility in the system around potential misspellings and situations where non-identical spellings may be used (e.g., omitting a diacritical mark in a name).

The framework 120 is a system or process for classifying relationships based on input data. For example, the framework 120 can be a machine-learning framework trained to produce inferences regarding a relationship based on input data (e.g., relationship data 110). The machine-learning framework can be a single framework or a combination of multiple frameworks. A variety of machine-learning frameworks, algorithms, or techniques can be used, including but not limited to supervised or unsupervised learning techniques. The machine-learning frameworks, algorithms, or techniques can include, but need not be limited to, logistic regression, decision forest, decision jungle, boosted decision tree, neural network, averaged perceptron, support vector machine, and Bayes' point machine, among others. In some examples, the framework 120 can be a self-hosted or self-managed framework. In other examples, the framework 120 can be hosted by a cloud service provider (e.g., the framework can be built and deployed using MICROSOFT AZURE MACHINE LEARNING).

The framework 120 can be configured to take the relationship data 110 as input. In some examples, the system 100 can include an engine for converting the relationship data 110 from a first format (e.g., the format the relationship data 110 is in when it is stored or obtained from a knowledge graph) and converted into a second format suitable for use with the framework 120.

The framework 120 can include multiple layers or other divisions, such as a first layer 122 and a second layer 124. The first layer 122 can act as a filter for the second layer 124. In some examples the first layer 122 can be a portion of the framework 120 or a framework itself configured or trained to classify the relationship represented by the relationship data 110 into a general family-member relationship (e.g., a family-member relationship or a self-relationship) or a non-family-member relationship (e.g. friend, coworker, or unrelated).

The second layer can be a portion of the framework 120 or a framework itself configured or trained to classify the relationship presented by the relationship data 110 into a self-relationship or a non-self, family-member relationship.

In an example, framework 120, the first layer 122, and/or the second layer 124 can use or be implanted as binary classifiers. In an example, gradient boosted classification tree algorithms with parameter sweeps are used. In some examples, gradient boosted decision trees can provide increased accuracy when classifying relationships. For example, gradient boosted decision trees may perform feature selection and may select a subset of features that are effective for the prediction in order to improve accuracy. Gradient boosted decision trees can attempt to minimize a loss function to minimize a cost (e.g., inaccuracy of the results). The loss function can be a cross entropy loss function, but other approaches may also be used. Other approaches can be used and may have their own advantages or drawbacks. In an example, random forests may be less accurate or take a longer time to converge on an accurate solution than gradient boosted decision trees.

The output of the framework 120, the first layer 122, and/or the second layer 124 can be associated with determining particular characteristics of a relationship present in the relationship data 110. The output can include, for example, a probability that the relationship is a certain kind of relationship (e.g., general family relationship; non-family relationship; self-relationship; and non-self, family-member relationship). The output can be a determination of whether the relationship data 110 is indicative of a particular kind of relationship.

The classification 130 can be the direct output of one of the layers 122, 124, or the framework 120 itself. In another example, the classification 130 can be produced by another component of the system 100 based on the output of the layers of the framework. The classification 130 can include a classification of the kind of relationship indicated by the relationship data 110. The classification 130 can also include metadata regarding the relationship or the classification of the relationship, such as a confidence value associated with a level of confidence in the prediction.

As should be appreciated, the various devices, components, etc., described with respect to FIG. 1 are not intended to limit the systems and methods to the particular components described. Accordingly, additional topology configurations may be used to practice the methods and systems herein and/or some components described may be excluded without departing from the methods and systems disclosed herein.

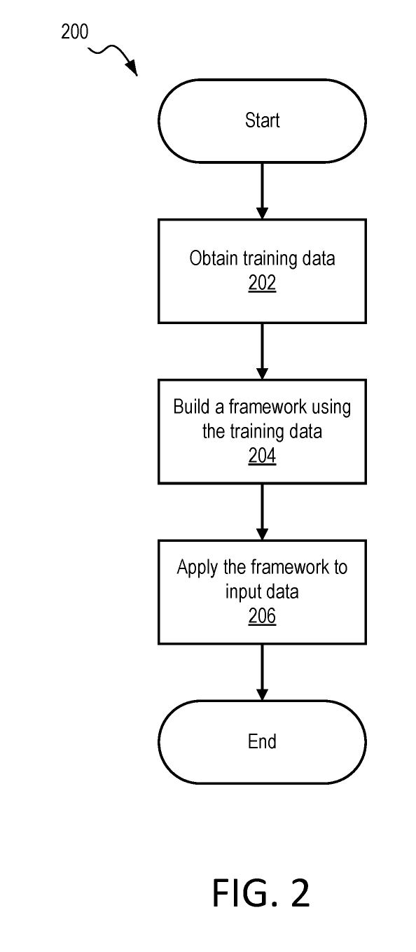

FIG. 2 illustrates an example process 200 for building a framework (e.g., framework 120) and applying the framework to input data (e.g., relationship data 110). The process 200 can begin with the flow moving to operation 202, which recites “obtain training data.” Following operation 202, the flow can move to operation 204, which recites “build a framework using the training data.” Following operation 204, the flow can move to operation 206, which recites, “apply the framework to input data.”

The process 200 can begin with operation 202, which includes obtaining training data. The training data is data that can be used to train the framework or a component thereof. The training data can include, for example, pre-classified or pre-labeled relationships based on particular relationship data.

In an example, obtaining training data can include using relationship information provided by users. This can include asking particular users for their relationship information (e.g., prompting a user to tag their relationships in a particular manner) or using information already provided by users (e.g., relationships tagged in a social network). While this information can be useful, some of the information provided in this way may skew the training. For example, only certain kinds of users may provide the relationship information, which may bias the training data towards the kinds of users who would provide that information. As another example, some users may provide erroneous data (e.g., marking friends as family members or failing to mark certain relationships in certain ways). One way to address these challenges is to supplement or replace the user-specified relationship information with determinations by judges.

Judges, such as human judges, can review and label relationship data as expressing a particular relationship or a particular kind of relationship. For example, a set of user pairs can be sampled from a social graph. This information can be presented to human judges, which then review and classify the relationship presented in the data. In some cases, the judges can research and obtain information not present in the data. To ensure quality, each pair of user data can be reviewed independently by multiple different judges. To further ensure quality, the review result can be accepted only if all or a plurality of judges reached the same decision. Once the review is completed, the decisions can be saved for model training. To still further ensure quality, the judges need not be limited to classifying the data as the same kinds of relationships the framework classifies. Instead, the judges can classify among a wider variety of relationships. For example, while the framework for which the training data is being collected may be designed to classify relationships as being a non-family-member relationship, a self-relationship, or a non-self, family-member relationship; the judges may be asked to classify the relationships as being coworker, friend, roommate, or other kind of relationship in addition to those relationships been classify by the framework. Quality can be improved by requiring consensus among the judges before a relationship is labeled in a particular way. This can improve quality because the judges are given many different categories to choose from but still converge on a particular relationship type.

The training data can be split into two different kinds of training data: data used to train the framework and data used to test the accuracy of the framework after it has been trained. Following operation 202, the flow can move to operation 204.

Operation 204 involves building a framework using the training data. The particular way of building the framework using the train data will vary depending on what kind of framework is used. However, in general, building of the framework involves creating an initial framework, passing the labeled training data through the framework, and modifying the framework based on the labeled training data. After the framework has been trained on some or all of the training data, the framework can be tested against the testing data to determine the accuracy of the framework. Depending on the results of the testing, various modifications may be made to the framework and the framework may be retrained. Once a sufficient accuracy has been achieved, the framework can then be used to the classify relationships without the need for human judged training data. Following operation 204, the flow can move to operation 206.

Operation 206 involves applying the framework to the input data. This can involve passing unlabeled relationship data as input to the framework to produce an output relevant to determining a relationship represented in the data.

As should be appreciated, operations 202-206 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

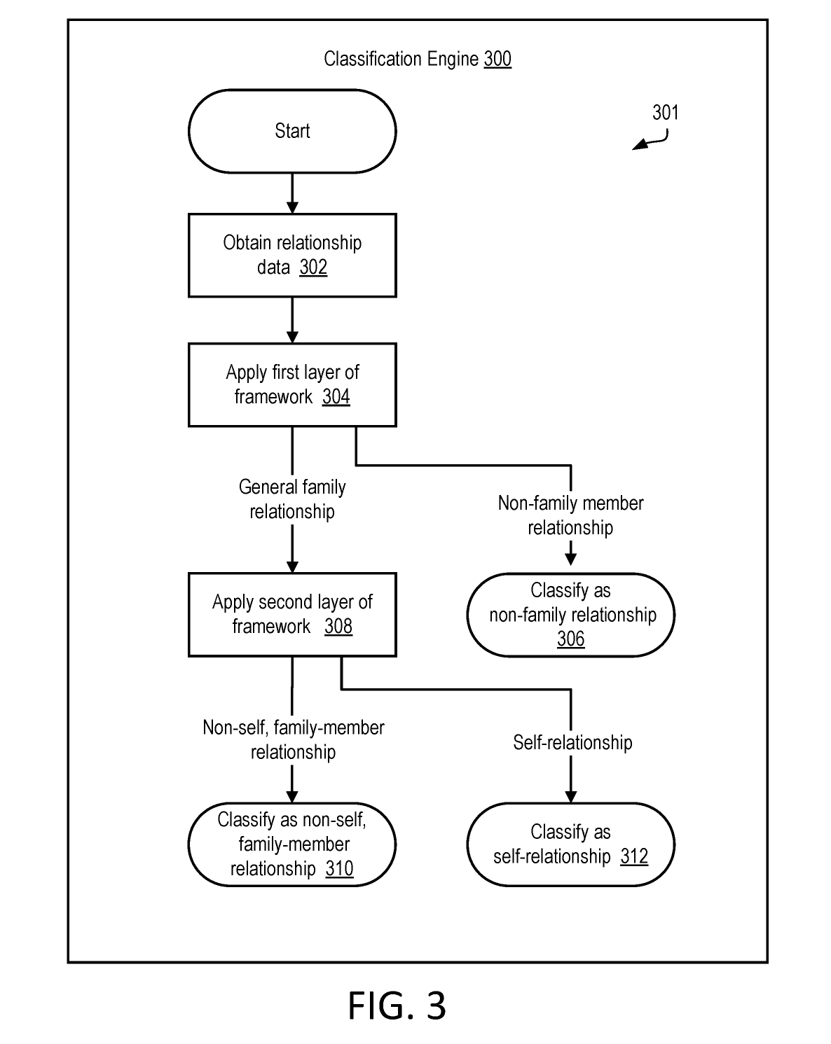

FIG. 3 illustrates an example classification engine 300 implementing a process 301 for classifying a relationship based on relationship data. The process can begin with the flow moving to operation 302, which recites “obtain relationship data.” Following operation 302, the flow can move to operation 304, which recites “apply first layer of framework.” If the first layer of the framework infers that the relationship expressed by the relationship data is a non-family relationship, the flow can move to operation 306, which recites, “classify as non-family relationship.” If the first layer of the framework instead infers that the relationship expressed by the relationship data is a general family relationship, then the flow can move to operation 308, which recites “apply second layer of framework.” If the second layer of the framework infers that the relationship expressed by the relationship data is a non-self, family-member relationship, then the flow can move to operation 310, which recites, “classify as non-self, family-member relationship.” If, instead, the second layer of the framework infers that the relationship expressed by the relationship data is a self-relationship, then the flow can move to operation 312, which recites, “classify as self-relationship.”

At operation 302, relationship data (e.g., relationship data 110) is obtained. The relationship data can be obtained in a variety of ways, including but not limited to those described with regard to relationship data 110. The relationship data can be passed to a framework (e.g., framework 120) for processing the relationship data. The framework may be pre-trained or pre-configured to provide output related to relationships represented by the relationship data. In an example, the framework is trained according to the process 200 shown and described in FIG. 2.

At operation 304, the relationship data is passed as input to a first layer of the framework (e.g., the first layer 122). In an example, the first layer produces an output that indicates a probability that a relationship associated with the relationship data is a general family-member relationship and/or a probability that it is a non-family-member relationship. The classification engine 300 can be configured to classify the relationship based on whether the probability passes a threshold. As a first example, if the probability of the relationship being a general family-member relationship is more likely than the probability of the relationship being a non-family-member relationship (e.g., there is about 51% probability that the relationship is a general family-member relationship), then the relationship is classified as a general family-member relationship. In another example, the threshold can be set to a 30% probability, so a relationship is classified as a general family-member relationship if the first layer determines there is at least a 30% probability that the relationship is a general family-member relationship. In certain implementations, a 30% threshold can provide a good balance, but other suitable thresholds can be used. In an example, a high threshold can be associated with fewer false positives and more false negatives.

If, based on the output of the first layer, it is determined that the relationship data is indicative of a non-family-member relationship, then the flow can move to operation 306. At operation 306, the relationship exhibited by the data is classified as a non-family-member relationship. This can involve writing data to a field associated with each evaluated user (e.g., nodes of the knowledge graph) and/or the relationship itself (e.g., the edge of the knowledge graph between the users). In another example, this can involve updating a field in a database or other data structure.

If the output of the first layer is indicative of a general family-member relationship, the flow can move to operation 308. At operation 308, a second layer of the framework (e.g., the second layer 124) can be applied to the relationship data. As output, the second layer of the framework can provide output indicative of the kind of relationship associated with the relationship data. As an example, the framework can produce an output that indicates a probability that the relationship data is a non-self, family-member relationship or a self-relationship.

If the output of the second layer indicates that the relationship data is indicative of a non-self, family-member relationship, then the flow can move to operation 310. At operation 310, the relationship is tagged or otherwise classified as a non-self, family-member relationship.

If the relationship data is indicative of a self-relationship, then the flow moves to operation 312. At operation 312, the relationship is tagged or otherwise classified as a self-relationship and appropriate action can be taken.

As should be appreciated, operations 302-312 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

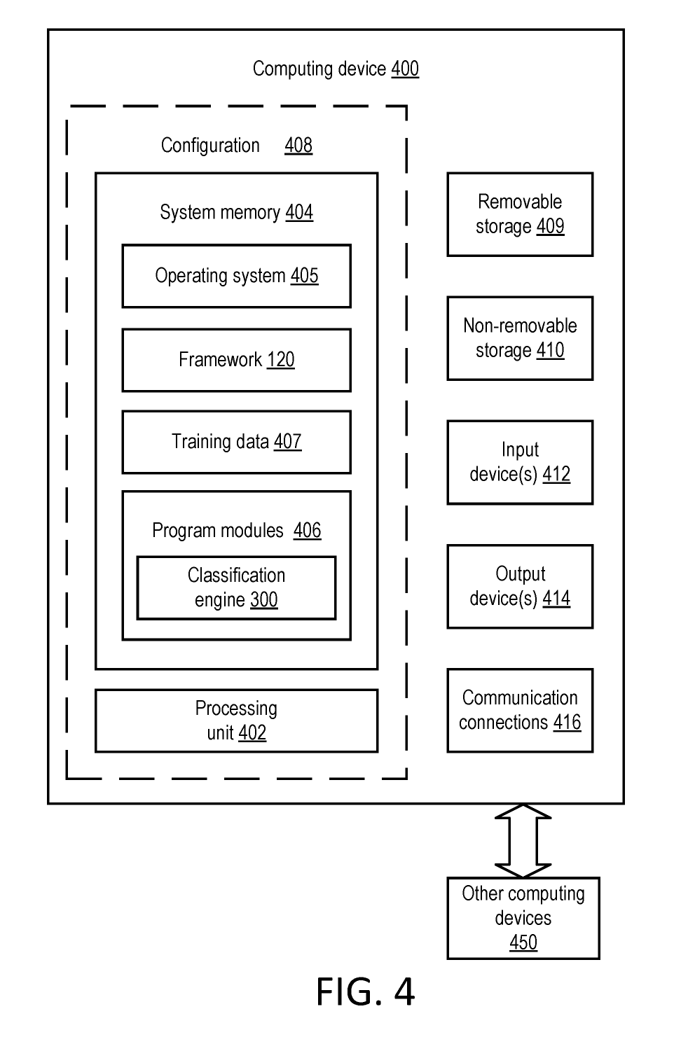

FIGS. 4-6 and the associated descriptions provide a discussion of a variety of operating environments in which aspects of the disclosure may be practiced. However, the devices and systems illustrated and discussed with respect to FIGS. 4-6 are for purposes of example and illustration and are not limiting of a vast number of computing device configurations that may be utilized for practicing aspects of the disclosure, as described herein.

FIG. 4 is a block diagram illustrating physical components (e.g., hardware) of a computing device 400 with which aspects of the disclosure may be practiced. The computing device components described below may have computer executable instructions for implementing a classification engine 300 or other methods disclosed herein. In a basic configuration, the computing device 400 may include at least one processing unit 402 (e.g., a central processing unit) and system memory 404. Depending on the configuration and type of computing device, the system memory 404 can comprise, but is not limited to, volatile storage (e.g., random access memory), non-volatile storage (e.g., read-only memory), flash memory, or any combination of such memories.

The system memory 404 may include the framework 120 and training data 407. The training data 407 may include data used to train the framework 120. The system memory 404 may include an operating system 405 suitable for running the classification engine 300 or one or more aspects described herein. The operating system 405, for example, may be suitable for controlling the operation of the computing device 400. Embodiments of the disclosure may be practiced in conjunction with a graphics library, other operating systems, or any other application program and is not limited to any particular application or system.

A basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, the aspects, as described herein. Other program modules may also be used in accordance with aspects of the present disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 400 may also have one or more input device(s) 412 such as a keyboard, a mouse, a pen, a sound or voice input device, a touch or swipe input device, and other input devices. The output device(s) 414 such as a display, speakers, a printer, and other output devices may also be included. The aforementioned devices are examples and others may be used. The computing device 400 may include one or more communication connections 416 allowing communications with other computing devices 450. Examples of suitable communication connections 416 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

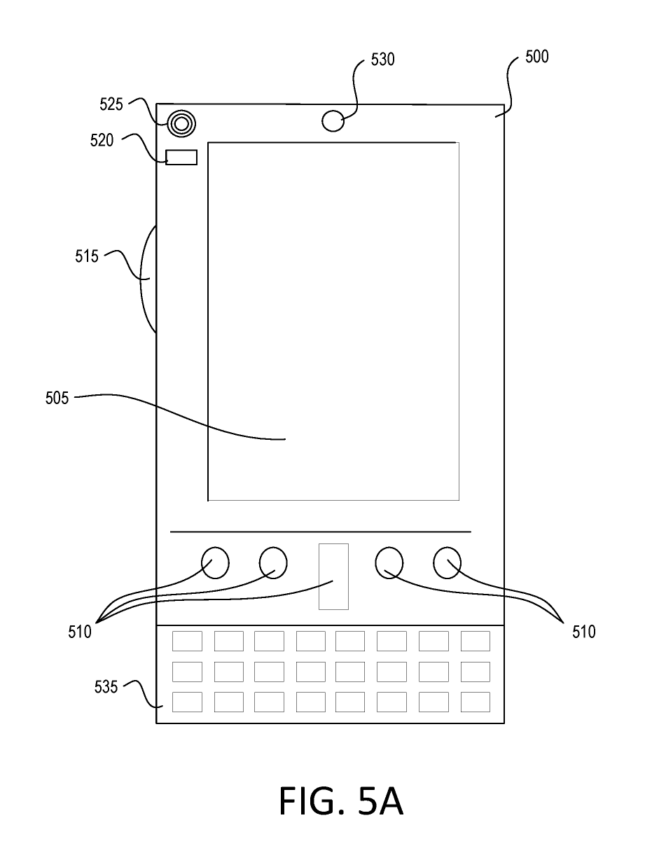

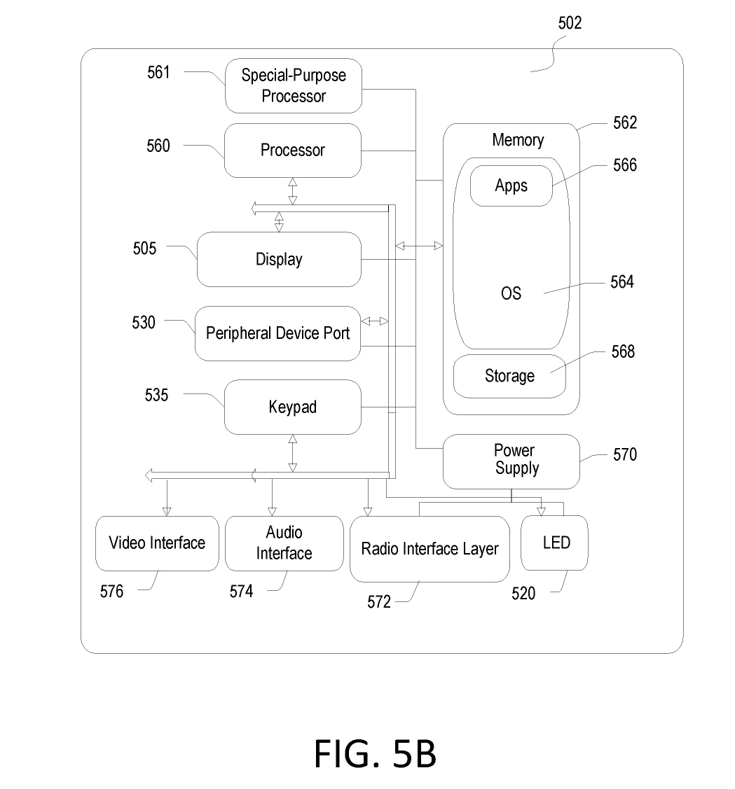

FIGS. 5A and 5B illustrate a mobile computing device 500, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative aspects, mobile computing device 500 may incorporate more or fewer input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device 500 can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as email or other messages used by an email application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500, including the instructions for determining relationships between users, as described herein.

The system 502 has a power supply 570, which may be implemented as one or more batteries. The power supply 570 may further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator 520 may be used to provide visual notifications, and/or an audio interface 574 may be used for producing audible notifications via an audio transducer 525 (e.g., audio transducer 525 illustrated in FIG. 5A). In the illustrated embodiment, the visual indicator 520 is a light emitting diode (LED) and the audio transducer 525 may be a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone may also serve as an audio sensor to facilitate control of notifications, as will be described below. The system 502 may further include a video interface 576 that enables an operation of peripheral device 530 (e.g., on-board camera) to record still images, video stream, and the like. Audio interface 574, video interface 576, and keyboard 535 may be operated to generate one or more messages as described herein.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data/information may be readily transferred between computing devices for storage and use according to well-known data/information transfer and storage means, including electronic mail and collaborative data/information sharing systems.

As should be appreciated, FIGS. 5A and 5B are described for purposes of illustrating the present methods and systems and are not intended to limit the disclosure to a particular sequence of steps or a particular combination of hardware or software components.

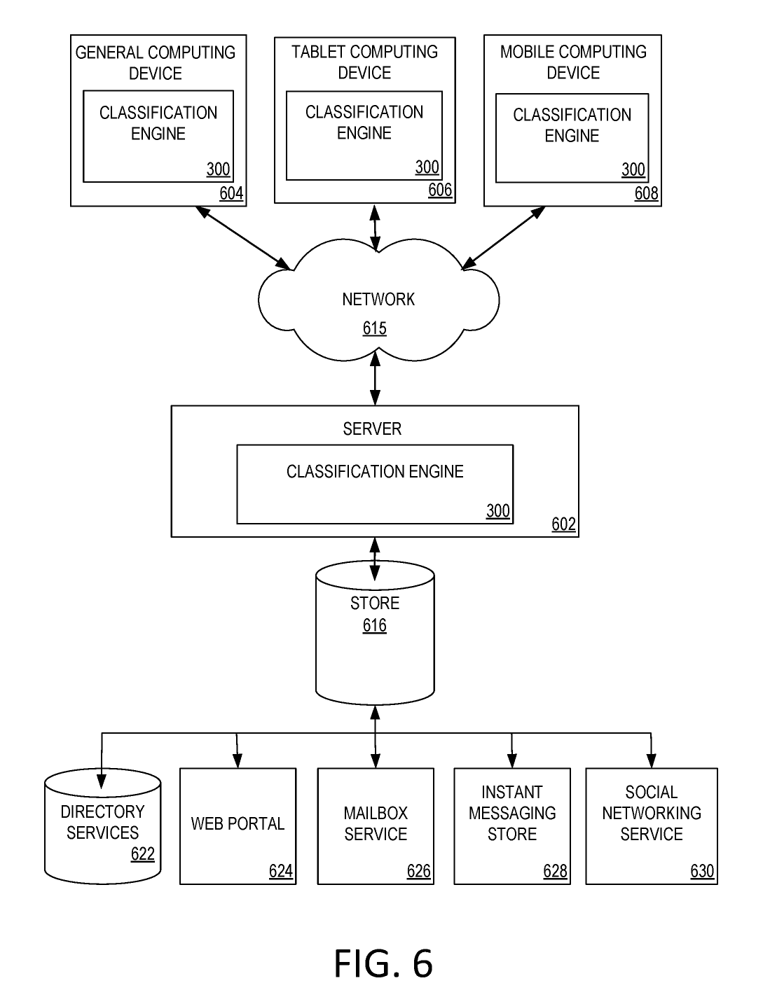

FIG. 6 illustrates one aspect of the architecture of a system for processing data received at a computing system from a remote source, such as a general computing device 604 (e.g., personal computer), tablet computing device 606, or mobile computing device 608, as described above. Content displayed at server device 602 may be stored in different communication channels or other storage types. For example, various messages may be received and/or stored using a directory service 622, a web portal 624, a mailbox service 626, an instant messaging store 628, or a social networking service 630. The classification engine 300 may be employed by a client that communicates with server device 602, and/or the classification engine 300 may be employed by server device 602. The server device 602 may provide data to and from a client computing device such as a general computing device 604, a tablet computing device 606 and/or a mobile computing device 608 (e.g., a smart phone) through a network 615. By way of example, the aspects described above with respect to FIGS. 1-3 may be embodied in a general computing device 604 (e.g., personal computer), a tablet computing device 606 and/or a mobile computing device 608 (e.g., a smart phone). Any of these embodiments of the computing devices may obtain content from the store 616, in addition to receiving graphical data useable to either be pre-processed at a graphic-originating system or post-processed at a receiving computing system.

As should be appreciated, FIG. 6 is described for purposes of illustrating the present methods and systems and is not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method comprising:
obtaining relationship data associated with a pair of users;
passing the relationship data as input to a first framework;
receiving a first output from the first framework, the first output indicating whether a relationship between the pair of users is a general family-member relationship or a non-family-member relationship;
responsive to the first output indicating a general family-member relationship, passing the relationship data as input to a second framework;
receiving a second output from the second framework, the second output indicating whether the relationship between the pair of users is a self-relationship or a non-self, family-member relationship; and
based at least in part on the second output, classifying the relationship between the pair of users as a self-relationship or a non-self, family-member relationship.

2. The computer-implemented method of claim 1, wherein the relationship data is passed as input to the second framework responsive to a value of the first output passing a threshold.

3. The computer-implemented method of claim 1, wherein the first output includes a probability that the relationship is a general family-member relationship or a probability that the relationship is a non-family-member relationship.

4. The computer-implemented method of claim 1, wherein the second output includes a probability that the relationship is a self-relationship or a probability that the relationship is a non-self-relationship.

5. The computer-implemented method of claim 1, wherein at least one of the first framework and the second framework comprises a trained machine-learning model.

6. The computer-implemented method of claim 5, wherein the trained machine-learning model is a boosted classification tree.

7. The computer-implemented method of claim 5, wherein the first framework and the second framework are trained binary classifiers.

8. The computer-implemented method of claim 1, further comprising:
providing unlabeled training data to one or more judges;
receiving a relationship classification from the one or more judges, the relationship classification indicative of a type of relationship associated with the unlabeled training data; and
labeling the unlabeled training data based on the relationship classification.

9. The computer-implemented method of claim 8, further comprising:
training at least one of the first framework and the second framework using the labeled training data.

10. The computer-implemented method of claim 1, further comprising:
obtaining the relationship data from an edge of a knowledge graph, wherein the edge connects at least two user nodes associated with the pair of users.

11. A computer-implemented method comprising:
obtaining input data associated with a relationship;
determining whether the input data is indicative of a family-member relationship or a non-family-member relationship;
responsive to determining that the input data is indicative of a family-member relationship, determining whether the input data is indicative of a self-relationship or a non-self, family-member relationship; and
classifying the relationship as a self-relationship or a non-self, family-member relationship.

12. The method of claim 11, wherein the relationship is a relationship between a user of a first account and a user of a second account.

13. The method of claim 11, wherein the input data is associated with an edge of a knowledge graph connecting user nodes associated with the relationship.

14. The system of claim 11, wherein determining whether the input data is indicative of a family-member relationship or a non-family-member relationship is conducted using a first framework, and wherein the first framework comprises a binary classifier trained to classify input data as associated with a family-member relationship or a non-family-member relationship.

15. The method of claim 11, wherein determining whether the input data is indicative of a self-relationship or a non-self, family-member relationship is conducted using a second framework, and wherein the second framework comprises a binary classifier trained to classify input data as associated with a self-relationship or a non-self, family-member relationship.

16. A system comprising:
a processor; and
a computer readable medium comprising instructions that, when executed by the processor, cause the processor to:
obtain input data associated with a relationship;
determine whether the input data is indicative of a family-member relationship or a non-family relationship using a first framework;
responsive to determining that the input data is indicative of a family-member relationship, determine whether the input data is indicative of a self-relationship or a non-self, family-member relationship using a second framework; and
classifying the relationship as one of a self-relationship and a non-self, family-member relationship.

17. The system of claim 16, wherein the relationship is a relationship between a user associated with a first account and a user associated with a second account.

18. The system of claim 16, wherein the input data is associated with an edge of a knowledge graph connecting at least two user nodes associated with the relationship.

19. The system of claim 16 wherein the first framework comprises a binary classifier trained to classify input data as associated with a family-member relationship or a non-family-member relationship.

20. The system of claim 19, wherein the second framework comprises a binary classifier trained to classify input data as associated with a self-relationship or a non-self, family-member relationship.
